(19) United States
(12) Patent Application Publication
(10) Pub. No.: US 2002/0195942 A1
(43) Pub. Date: Dec. 26, 2002

(54) ARC discharge lamp, glass faceplate and method therefor

(76) Inventors: Takakazu Hayashi, Iwata-gun (JP); Yasuo Kusumi, Hamura City (JP); Kenichi Minematsu, Shizuoka (JP); Akira Okada, Shizuoka (JP); Christophe Remy, Thomery (FR)

Correspondence Address: CORNING INCORPORATED, SP-TI-3-1, CORNING, NY, 14831

(21) Appl. No.: 10/152,220

(22) Filed: May 20, 2002

(30) Foreign Application Priority Data
May 23, 2001 (EP) 01401362.7

(51) Int. Cl. H01J 61/35

(52) U.S. Cl. 313/635

(57) ABSTRACT

An arc discharge lamp, particularly an ultra high pressure lamp, a glass faceplate for such lamp and a method of controlling transmission during lamp operation, the glass containing cuprous halide microcrystals dispersed therein and being capable of absorbing radiation below a wavelength of about 420 nm, the glass faceplate having a film that reflects ultra-violet radiation, and the method comprising maintaining the faceplate at a low temperature during lamp operation to prevent a phase change in the duprous halide.

### FIELD OF THE INVENTION

This invention relates to an arc discharge lamp having a glass face plate, a glass faceplate of the lamp and a method of controlling transmission through the glass faceplate.

### BACKGROUND OF THE INVENTION

Electric lamps, such as Xenon lamps, metal halide lamps and high pressure mercury lamps, are used in projection displays as a light source. These discharge lamps emit ultraviolet (UV) radiation which is harmful to human eyes and display components made of organic materials. Organic polarizer films for projection LCDs and holographic optical components (HOE) used in various projection optical components are especially sensitive to UV light. These materials deteriorate under strong UV irradiation thereby resulting in display contrast reduction. In order to prevent this, UV-cut filters, either made of UV-absorbing glass or having UV-reflective coatings, have been positioned in the optical path of projection displays.

Glasses containing semiconductor micro-crystals that absorb ultra-violet radiation sharply up to a given wavelength, due to exciton absorption of the semiconductor micro-crystals, are well known in the glass art. Such glasses are commonly referred to as “colorless,” unless a colorant is intentionally added.

It has been observed, however, that these so-called “colorless” glasses tend to have a slight yellow color. For many purposes, this is not objectionable. Where it is objectionable, an application filed by one of us, PCT/EP00/00989, discloses glasses in which this yellow coloration is minimized. This is primarily due to composition control, in particular, maintaining a Br/Cl ratio greater than 1:1 by weight.

The present invention is generally applicable to ultra-violet absorbing glasses containing copper halide. However, the glasses described in the PCT application mentioned above represent a preferred embodiment. The compositions of these glasses consist essentially of, as expressed in cationic percentages:

| | | | |
|---|---|---|---|
| 23-73% | SiO₂ | 0.125-1% | Cu₂O |
| 15-45% | B₂O₃ | 0-1% | CdO |
| 0-24% | Al₂O₃ | 0-5% | ZrO₂ |
| 0-12% | Li₂O | 0-1.75% | Cl |
| 0-20% | No₂O | 0-2% | Br |
| 0-12% | K₂O | 0.25-2% | Cl + Br |
| 0.25-5% | CaO + BaO + SrO | 0-2% | F |

the halogens being expressed in weight percent and the ratio of Br:Cl by weight being greater than 1:1.

As indicated above, the problems caused by ultra-violet radiation are common to any electric lamp that emits such radiation. The invention disclosed hereafter is generally applicable to any such lamp. However, the invention was made in the course of developing an improved ultra high pressure (UHP) lamp. Therefore, the description will be made with reference to such a lamp. The broader application will be apparent to those having skill in the art.

An ultra high pressure (UHP) lamp has become a light source for image projectors. In particular, such a lamp is finding increasing use in LCD and DMD projectors. In such projectors, the lamp can provide the correct color balance in conjunction with sufficient light intensity.

In addition to the desired, high intensity light, the lamp also emits a high intensity, ultra-violet (UV) component that has wavelengths less than 400 nm. This UV component not only has little benefit with respect to the desired color balance, but tends to deteriorate other components in the lamp.

In order to alleviate this problem, glass filters that cut the UV transmission are commonly incorporated in the optics of a lamp. The glass filter exhibits a sharp cutoff for the undesired UV radiation. However, the absorbed UV radiation tends to discolor the filter glass, thereby reducing the desired transmittance of visible radiation.

In a typical UHP lamp, the discoloration becomes apparent after an exposure time of a few hundred hours depending on UV intensity. With increasing exposure, the effect increases. This increasingly limits lamp effectiveness. Location of the filter in the lamp makes its replacement difficult. Accordingly, it has become customary to accept the decreased performance until the entire lamp is replaced. This occurs after about 2,000 hours use.

It is a primary purpose of the present invention to provide a projector lamp construction wherein the UV-radiation problem just described is alleviated.

It is a more specific purpose to provide an ultra high pressure lamp wherein deleterious UV transmission is essentially eliminated over the range of 300-400 nm.

It is a further purpose to provide a faceplate for an ultra high pressure lamp that has a sharp radiation cutoff that essentially avoids UV transmission over the life of the lamp.

Finally, it is a purpose of the invention to provide an improved glass faceplate for an arc discharge lamp, in particular, an ultra high pressure lamp.

### SUMMARY OF THE INVENTION

One aspect of the present invention is an arc discharge lamp having a glass faceplate, the glass being a clear, non-photochromic, silicate glass containing precipitated, cuprous halide microcrystals, being capable of absorbing radiation below about 420 nm wavelength to provide a sharp cutoff for transmission of such radiation, and having an ultra-violet reflecting film on the inner face of the faceplate, whereby the faceplate is maintained at a low temperature during the life of the lamp.

Another aspect of the invention is a method of avoiding UV transmission through a face plate in an arc discharge lamp, the glass faceplate containing cuprous halide microcrystals, the method comprising maintaining the faceplate at a temperature higher than 50° C., but not over a temperature at which the microcrystals undergo a phase change during lamp operation, whereby UV transmission is avoided.

### BRIEF DESCRIPTION OF THE DRAWINGS

FIG. 1 is a side view of a typical, ultra high pressure lamp with a portion of the wall removed for better illustration,

FIG. 2 is an enlarged, cross-sectional view of the faceplate of the lamp of FIG. 1 taken along line 2-2, and

FIG. 3 is a graphical representation in which the transmittance curve for a faceplate in accordance with the present invention is compared with that for a prior faceplate.

### DETAILED DESCRIPTION OF THE INVENTION

FIG. 1, in the accompanying drawing, shows a side view of a typical ultra high pressure lamp 10 with a portion of the side wall of the lamp envelope 12 broken away for purposes of illustration. The essential components of lamp 10, for present purposes, are a light source 14 and a face plate 16.

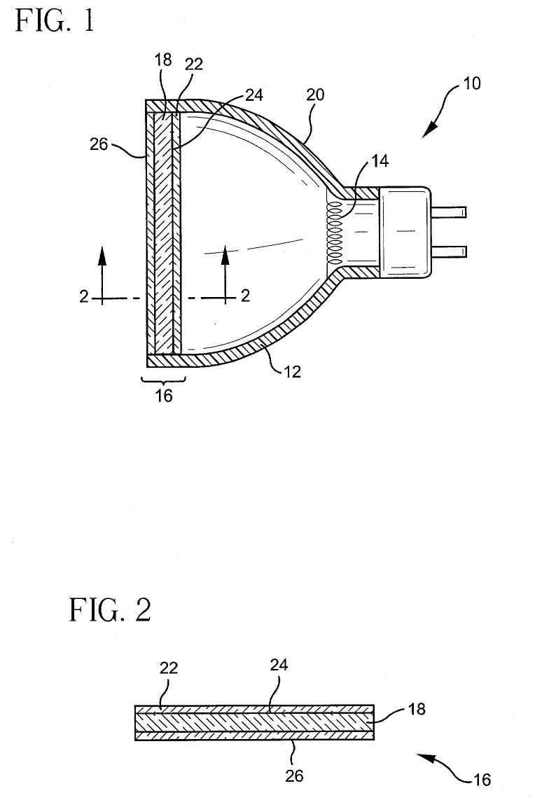

FIG. 2 is an enlarged view in cross-section of faceplate 16 taken along line 2-2 in FIG. 1. Faceplate 16 comprises a circular plate of flat, UV-absorbing glass 18 sealed to the periphery of the open, outer end of lamp envelope 20. Glass 18 is a critical element in the present lamp. Flat glass member 18 has a UV-reflecting film or coating 22 applied to its inner face 24. Face 24 is the flat surface facing light source 14 mounted in the rear of lamp 10. Film 22 is a critical element for present purposes. It reflects ultra-violet radiation emitted by light source 14. Optionally, an anti-reflecting film 26 may be applied to the outer flat face 30 of glass member 18. This minimizes loss of light output by reflection into the lamp from the glass-air interface. Such anti-reflecting films, and their production, have long been well known in the coating art.

As noted earlier, small, ultra high pressure, mercury lamps have become an accepted light source for many purposes, in particular LCD and DMD light projectors. In order to avoid the undesired, high intensity, ultra-violet radiation, it has become common practice to employ UV-absorbing glass filters mounted within a projection optical system. Such filters provide a sharp, ultra-violet cutoff due to exciton absorption of the semiconductor micro-crystals in the glass. The UV cutoff can be adjusted by optimizing the crystal composition and crystal size at a desired wavelength, commonly about 420 nm. While very effective for that purpose, the ultra-violet absorption by such filters quickly causes the filter to become discolored. This, in turn, leads to reduction in transmission of the desired, visible wavelength radiation.

The present invention is based on using a glass containing cuprous halide microcrystals precipitated within the glass as a face plate of a UV emitting lamp. With a proper thermal processing, this glass has a certain size distribution of copper halide microcrystals, hence a sharp UV cutoff in transmission in the vicinity of 420 nm. However, the absorbed UV energy is transformed to thermal energy. Under very strong UV irradiation, the cuprous halide microcrystals start to undergo a phase change in the glass at a temperature as low as 200° C. As a result, they lose their UV absorption characteristics. We have now found that the undesirable change can be avoided if certain thermal conditions (preferably, a temperature less than 200° C.) are maintained in the face plate.

We have found that the cuprous halide microcrystals must be maintained in the cuprous halide crystalline state. To this end, the glass face plate 16 must be maintained at a low temperature, at least below 300° C., and preferably below 200° C. At higher temperatures, there is a tendency for the cuprous halide microcrystals to undergo a phase change in the glass, either by melting or by oxidation to the cupric state, and thus lose their UV-absorbing ability.

This was demonstrated by comparing the effect of UV radiation from a UHP lamp on two, circular sheets of glass, the glass having the composition shown below. One sheet was provided with a standard anti-reflecting (AR) coating (5 alternating layers of SiO₂ and TiO₂). The other sheet was provided with an ultra-violet cut (UVC) coating that reflects UV radiation. That provides a transmission cutoff at about 420° C. in accordance with the present invention. Both sheets were subjected to the radiation from a UHP lamp over a period of time.

The AR-coated sheet initially cuts the UV. However, after a period of treatment, the sheet started to transmit UV radiation. This gradual change is due to the glass temperature undergoing an increase due to UV absorption. With the temperature increase, the crystals start to change phase, and are no longer effective to absorb UV. In contrast, the sheet having the UVC coating in accordance with the present invention did not show this change. Rather, it's transmission characteristics remained essentially unchanged.

A critical factor in attaining this desired thermal condition is reduction in the amount of ultra-violet radiation entering the absorbing glass 18. To this end, an ultra-violet reflecting coating 22 is applied to the inner surface 24 of faceplate glass 18. This reduction in the amount of radiation absorbed in glass 18 enables maintaining the glass temperature below a temperature at which a phase change occurs.

To demonstrate the beneficial effect of the present invention, two, circular sheets of a flat, ultra-violet cutoff glass, having a thickness of 2 mm., were prepared. The glass had a composition, in percent by weight as calculated from the batch, as follows:

| | | | |
|---|---|---|---|
| SiO₂ | 49.2 | BaO | 4.8 |
| B₂O₃ | 20.6 | CuO | 0.45 |
| Al₂O₃ | 8.7 | Cl | 0.05 |
| ZrO₂ | 3.5 | Br | 0.92 |
| Li₂O | 2.1 | SnO | 0.51 |
| Na₂O | 3.4 | Nd₂O₃ | 0.05 |
| K₂O | 5.7. | | |

The inside surface of one of the circular glass sheets was provided with a coating that reflects ultra-violet radiation. Also, a standard, anti-reflection coating was applied to the opposite, outer face of the glass sheet. While this anti-reflection coating is optional, it does improve transmission of visible radiation. The other circular sheet of glass, a conventional face plate, remained uncoated, and otherwise untreated, to permit comparative testing.

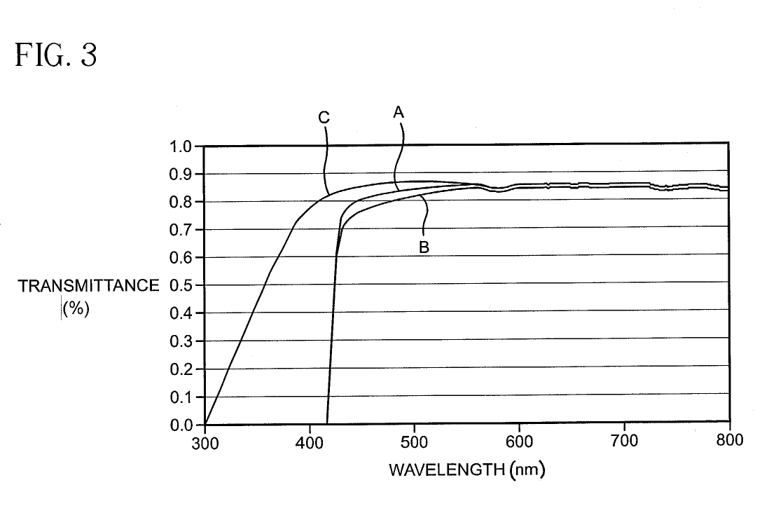

Both test pieces were exposed for 2400 hours to the radiation intensity of a 150 W UHP lamp without a faceplate. The intensity level was about 200 m w/cm². Transmittance values for each glass plate were measured both before and following their radiation exposure. The measured values were plotted, and are shown as transmittance curves in FIG. 3.

FIG. 3 is a graphical representation in which radiation wavelengths are plotted in nanometers on the horizontal axis. Transmittance values in percent are plotted on the vertical axis. In FIG. 3, transmittance values were measured on the glass test pieces prior to exposure. The values were essentially identical, and are shown as Curve A in FIG. 3.

Subsequent to exposure, transmittance values were measured on each test piece. The values thus obtained were plotted as Curves B and C, respectively. Curve B represents transmittance through the test piece prepared in accordance with the present invention, that is, having the ultra-violet coating (UVC).

It will be seen that, even after 2400 hours of exposure, essentially no change in transmission characteristic occurred for the UVC-coated test piece. Thus, no appreciable change could be observed between Curve A and Curve B following the exposure. A slight transmittance increase is observed at approximately 450 nm. This is considered to be caused by densification of the UVC coating. In contrast, the transmittance values for the untreated test piece (Curve C) were markedly changed. In particular, a substantial transmission developed in the ultra violet transmitting region, between 300 and 400 nm. This is a clear indication that the a present invention has a significant effect in essentially eliminating the effect of ultra violet radiation.

In a preferred embodiment, the mechanical strength of the faceplate glass is enhanced by chemical tempering of the glass. A bath composed of 99.5% potassium nitrate and 0.5% silica acid is employed. The glass is immersed in this bath for 16 hours while the bath is maintained at a temperature of 450° C.

We claim:

1. An arc discharge lamp having a glass faceplate, the glass being a clear, non-photochromic, silicate glass containing precipitated, cuprous halide microcrystals dispersed therein, the glass faceplate being capable of absorbing radiation below about 420 nm wavelength to provide a sharp cutoff for transmission of such radiation, and having an ultra-violet reflecting film on the inner face of the faceplate, whereby the faceplate is maintained at a low temperature during the life of the lamp.

2. An arc discharge lamp in accordance with claim 1, wherein the faceplate is maintained at a temperature above 50° C., but below a temperature at which the microcyrstals undergo a phase change.

3. An arc discharge lamp in accordance with claim 1 that has an anti-reflecting coating on its outer face to minimize loss of light output by reflection.

4. An arc discharge lamp in accordance with claim 1 having an ultra-violet filter mounted within the lamp envelope.

5. An ultra high pressure lamp in accordance with claim 1.

6. A method of controlling transmission through a glass faceplate in an arc discharge lamp, the glass faceplate containing cuprous halide microcrystals dispersed in the glass, the method comprising maintaining the faceplate at a temperature above 50° C., but not over a temperature at which the microcrystals undergo a phase change during lamp operation, whereby UV transmission is essentially avoided.

7. A method of controlling transmission through a glass faceplate in accordance with claim 6 which comprises providing a film that reflects ultra-violet radiation on the inside face of the glass faceplate.

8. In an arc discharge lamp, a glass faceplate composed of a clear, non-photochromic, silicate glass containing precipitated, cuprous halide microcrystals dispersed therein, the glass faceplate being capable of absorbing radiation below about 420 nm wavelength to provide a sharp cutoff for transmission of such radiation, and having an ultra-violet reflecting film on the inner face of the faceplate, whereby the faceplate is maintained at a low temperature during the life of the lamp.
